(19) United States
(12) Patent Application Publication
(10) Pub. No.: US 2026/0246621 A1
(43) Pub. Date: Aug. 20, 2026

(54) KEY PROVISION SYSTEM, METHOD, AND PROGRAM

(71) Applicant: NTT, Inc., Tokyo (JP)

(72) Inventors: Sakae CHIKARA, Tokyo (JP); Tsunekazu SAITO, Tokyo (JP)

(21) Appl. No.: 19/159,427

(22) PCT Filed: Mar. 9, 2023
(86) PCT No.: PCT/JP2023/009157

§ 371 Date: Aug. 25, 2025

(51) Int. Cl. H04L 9/08

(52) U.S. Cl. CPC H04L 9/085; H04L 9/0819; H04L 9/0861

(57) ABSTRACT

A key provision system according to the present disclosure includes a first terminal on a master side of key sharing, a first key server capable of providing a shared key to the first terminal, a second terminal on a slave side of the key sharing, and a second key server capable of providing a shared key to the second terminal, wherein the first key server includes: a first key generation unit configured to, when receiving a key request from the first terminal, generate the shared key and second identification information for identifying the shared key by using one or more keys shared with the second key server by one or more key sharing methods and first identification information for identifying each of the one or more keys; a key notification unit configured to transmit a key notification including the shared key and the second identification information to the first terminal; and a first transmission unit configured to transmit the second identification information to the second key server when receiving the second identification information from the first terminal, and the second key server includes: a second key generation unit configured to generate the shared key and the second identification information by using the one or more keys shared with the first key server by the one or more key sharing methods and first identification information for identifying each of the one or more keys; a second transmission unit configured to transmit the second identification information to the second terminal when receiving the second identification information from the first key server; and a third transmission unit configured to, when receiving a key acquisition request including the second identification information from the second terminal, transmit the shared key identified by the second identification information to the second terminal.

### TECHNICAL FIELD

The present disclosure relates to a key provision system, a method, and a program.

### BACKGROUND ART

A key sharing protocol called quantum key distribution (QKD) is known (see, for example, Non-Patent Literatures 1 and 2). QKD is a technique in which a key for concealing communication between two parties is shared by quantum teleportation, and data encrypted using the key is transmitted and received (encrypted communication).

In QKD, an entity that performs key sharing (key management entity (KME)) and an entity that performs data transmission and reception (secure application entity (SAE)) exist on different devices, and keys are shared and accumulated between KMEs using an optical communication network achieved by an optical fiber cable or the like. Then, when encrypted communication is performed between SAEs, the SAE on the transmission side acquires a key and a key ID from the KME corresponding thereto, and notifies the SAE on the reception side of the key ID. In the SAE on the reception side, the key identified by the key ID notified from the SAE on the transmission side is acquired from the KME corresponding to the SAE on the reception side. Thus, the same key is obtained between the SAE on the transmission side and the SAE on the reception side, and encrypted communication can be performed.

### CITATION LIST

### Non-Patent Literature

Non-Patent Literature 1: ETSI GS QKD 004 V2.1.1 (2020-08) Quantum Key Distribution (QKD);

### Application Interface

Non-Patent Literature 2: ETSI GS QKD 014 V1.1.1 (2019-02) Quantum Key Distribution (QKD); Protocol and data format of REST-based key delivery API

### SUMMARY OF INVENTION

### Technical Problem

In recent years, a method of generating a key (hereinafter referred to as a shared key) used for encrypting data transmitted and received between a transmission side and a reception side by combining keys of one or more key sharing methods including QKD and the like has been studied. On the other hand, in recent years, the shared key is not necessarily used for encrypted communication, and for example, it is assumed that the shared key is used in a case where encrypted data on a shared storage is used by a plurality of persons. In such a usage example, it is not necessary for users who use the shared key to directly communicate with each other, and thus, for example, there may be a case where communication cannot be performed between the SAE (master) that requests the KME to generate the shared key and other SAEs (slaves). In this case, there arises a problem that the key ID cannot be notified from the SAE on the master side to the SAE on the slave side, and the shared key generated between the KMEs cannot be shared between the SAEs.

The present disclosure has been made in view of the above points, and provides a technology capable of sharing a shared key even in a case where communication cannot be performed between entities using a key.

### Solution to Problem

A key provision system according to the present disclosure includes a first terminal on a master side of key sharing, a first key server capable of providing a shared key to the first terminal, a second terminal on a slave side of the key sharing, and a second key server capable of providing a shared key to the second terminal, wherein the first key server includes: a first key generation unit configured to, when receiving a key request from the first terminal, generate the shared key and second identification information for identifying the shared key by using one or more keys shared with the second key server by one or more key sharing methods and first identification information for identifying each of the one or more keys; a key notification unit configured to transmit a key notification including the shared key and the second identification information to the first terminal; and a first transmission unit configured to transmit the second identification information to the second key server when receiving the second identification information from the first terminal, and the second key server includes: a second key generation unit configured to generate the shared key and the second identification information by using the one or more keys shared with the first key server by the one or more key sharing methods and first identification information for identifying each of the one or more keys; a second transmission unit configured to transmit the second identification information to the second terminal when receiving the second identification information from the first key server; and
a third transmission unit configured to, when receiving a key acquisition request including the second identification information from the second terminal, transmit the shared key identified by the second identification information to the second terminal.

### Advantageous Effects of Invention

A technology capable of sharing a shared key even in a case where communication cannot be performed between entities using a key is provided.

### BRIEF DESCRIPTION OF DRAWINGS

FIG. 1 is a diagram illustrating an example of an overall configuration of a key provision system according to an embodiment.

FIG. 2 is a diagram illustrating an example of a detailed functional configuration of an AP according to the embodiment.

FIG. 3 is a diagram illustrating an example of a detailed functional configuration of a protocol conversion unit according to the embodiment.

FIG. 4 is a sequence diagram illustrating an example of key sharing processing according to the embodiment.

FIG. 5 is a sequence diagram illustrating an example of shared key use start processing according to the embodiment.

FIG. 6 is a diagram illustrating a usage example of a shared key.

FIG. 7 is a sequence diagram illustrating an example of switching processing according to the embodiment.

FIG. 8 is a diagram illustrating an example of a hardware configuration of a computer.

### DESCRIPTION OF EMBODIMENTS

Hereinafter, an embodiment of the present invention will be described. Hereinafter, a key provision system 1 will be described in which a shared key is generated by combining keys of one or more key sharing methods among a plurality of key sharing methods including QKD, and each entity can share the shared key even in a case where communication cannot be performed between entities using the shared key. In addition, a case of switching the key sharing method to another key sharing method when a certain key sharing method becomes unable to be used for some reason at this time (for example, an error or the like) will also be described.

Here, examples of the key sharing method include a pre-shared key (PSK) method, a key exchange mechanism (KEM), and the like, in addition to QKD. KEM is, for example, a key sharing method using an encryption system such as RSA, elliptical encryption, or post quantum cryptography (PQC), and in particular, KEM using post quantum cryptography is a type of post-quantum cryptography-based key distribution (PQKD), and is also called PQC-KEM or the like. Hereinafter, it is assumed that QKD, PSK, and KEM (PQC-KEM) are used as key sharing methods, and a shared key is generated by combining keys of one or more key sharing methods among these key sharing methods. Note that the key sharing method may be referred to as a key sharing protocol, a key exchange protocol, or the like, and refers to a technique for sharing the same key between the two.

With the key provision system 1 described above, it is possible to generate a shared key obtained by combining keys of one or more key sharing methods, and with this shared key, the application on the master side and the application on the slave side can use the shared key. In addition, even if a certain key sharing method cannot be used for some reason (for example, an error or the like), it is possible to switch to another key sharing method, and thus it is possible to ensure continuity of a service that requires encrypted communication (in other words, availability of the service can be increased). Note that the application on the master side is an application that requests generation of a shared key, and the application on the slave side is an application other than the master among applications that use the shared key.

### Problems in Combining Keys of a Plurality of Key Sharing Methods

In a case where keys of a plurality of key sharing methods are combined, authentication-certification methods and key identification methods are different depending on the key sharing method, and thus it is considered that security is not sufficient only by simply combining keys of a plurality of key sharing methods.

For example, in the KEM, a specific authentication-certification method is entrusted to an application, but authentication-certification can be regarded as being integrated, and if mutual authentication is performed, authorization (access control) using a key can be treated as being performed at the same time. This is because the KEM generates a key by mutual operation between the transmission side and the reception side by an algorithm based on public key cryptography. On the other hand, in the QKD, a mechanism that gives the SAE access control (authorization) to the key corresponding to the key ID acquired from the KME is not specified, and even if mutual authentication is performed between the SAEs by some authentication method, it is unclear whether the authorization to the key corresponding to the key ID is correctly performed. In addition, in PSK, it can be considered that authentication-certification is performed by setting a key by an administrator, a user, or the like. As described above, the authentication-certification method may be different depending on the key sharing method.

Further, for example, in the KEM, a key is identified by session information such as a session ID. On the other hand, in QKD, a key is identified by a key ID. In PSK, generally, there is no information uniquely identifying a key, and a key is indirectly identified by, for example, some information or the like depending on a protocol used for communication with a communication partner. As described above, the key identification method is also different depending on the key sharing method.

Accordingly, in the following embodiment, a method of generating a shared key by combining keys of one or more key sharing methods among a plurality of key sharing methods including QKD without depending on an authentication-certification method or a key identification method will be described.

### Modeling of Key Sharing Method

In order to solve the above-described first problem that the authentication-certification method may be different, key sharing methods other than QKD are modeled similarly to QKD. That is, in QKD, there are two entities of a KME that is an entity (that is, an entity that executes processing logic for achieving key sharing at a time) that performs key sharing, and an SAE that is an entity that performs encrypted communication using a key shared between the KMEs. Accordingly, other key sharing methods other than QKD are also separated into two entities of KME and SAE, and modeling similar to QKD is performed.

For example, in PSK, a part that receives key setting from an administrator, a user, or the like can be modeled as KME, and a part (application) that performs encrypted communication using the key can be modeled as SAE. Similarly, for example, in the KEM, a portion that executes processing for sharing a key with a communication partner can be modeled as the KME, and a portion (application) that performs encrypted communication using the key can be modeled as the SAE.

Hereinafter, it is assumed that PSK and KEM are modeled in a model that is separated into SAE and KME described above.

### Case Where Communication Cannot be Performed Between Entities Using a Shared Key

Even if the shared key is generated between the KMEs on the master side and the slave side, in a case where communication cannot be performed between the applications on the master side and the slave side, the shared key cannot be shared between these applications. This is because the key identification information notified from the application on the master side is necessary for the application on the slave side to acquire the same shared key as the application on the master side. Hereinafter, the key identification information of the shared key is also referred to as “shared key identification information”.

Accordingly, in the following, a method will be described in which, when shared key identification information is transmitted from a key server having a function of providing a shared key shared between KMEs to an application on the master side, the shared key identification information is transmitted to the key server in a callback manner, and the shared key identification information is notified to the application on the slave side via the key server. Thus, even when the application on the master side and the application on the slave side cannot communicate with each other, the application on the slave side can be notified of the shared key identification information, so that the shared key identified by the shared key identification information can be shared between the applications on the master side and the slave side.

Note that examples of the case where the application on the master side and the application on the slave side cannot communicate with each other include a case where the application on the master side and the application on the slave side exist in different networks, and communication of the application in the network with an external network is restricted.

### Overall Configuration Example of Key Provision System 1

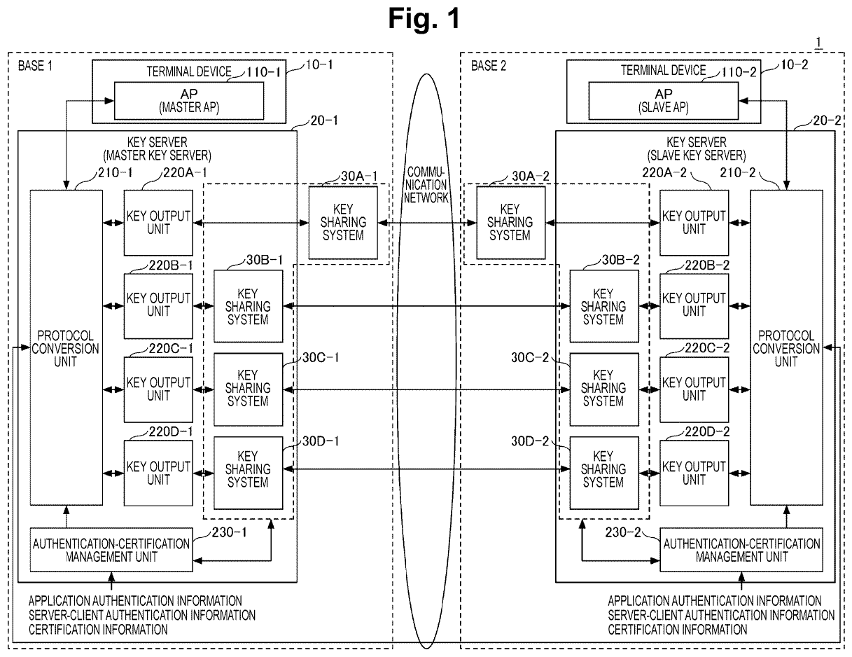

FIG. 1 illustrates an overall configuration example of a key provision system 1 according to an embodiment. FIG. 1 illustrates the key provision system 1 in a case where a base 1 and a base 2 exist as an example. In the key provision system 1 illustrated in FIG. 1, a case is illustrated in which a terminal device 10-1 having an application on the master side and a key server 20-1 having a function of providing a shared key to the application are a base 1, and a terminal device 10-2 having an application on the slave side and a key server 20-2 having a function of providing a shared key to the application are a base 2. Further, in the key provision system 1 illustrated in FIG. 1, a key sharing system 30A-1, a key provision system 30B-1, a key sharing system 30C-1, and a key sharing system 30D-1 that function as a KME of key sharing methods usable by the key server 20-1, and correspond to these key sharing methods are also illustrated. Similarly, a key sharing system 30A-2, a key sharing system 30B-2, a key sharing system 30C-2, and a key sharing system 30D-2 that function as a KME of key sharing methods usable by the key server 20-2, and correspond to these key sharing methods are also illustrated.

Here, it is assumed that the key sharing system 30A-1 and the key sharing system 30A-2 can share a key by a certain key sharing method (for example, QKD) in which the KME and the SAE exist on different devices. On the other hand, it is assumed that the key sharing system 30B-1 and the key sharing system 30B-2 can share a key by a certain key sharing method (for example, PSK and KEM) in which the KME and the SAE exist on the same device. Similarly, it is assumed that the key sharing system 30C-1 and the key sharing system 30C-2 or the key sharing system 30D-1 and the key sharing system 30D-2 can share a key by a certain key sharing method (for example, PSK and KEM) in which the KME and the SAE exist on the same device. Hereinafter, as an example, it is assumed that the key sharing system 30A-1 and the key sharing system 30A-2 correspond to QKD, the key sharing system 30B-1 and the key sharing system 30B-2 correspond to a certain KEM (hereinafter referred to as KEM-A), the key sharing system 30C-1 and the key sharing system 30C-2 correspond to another certain KEM (hereinafter, referred to as KEM-B), and the key sharing system 30D-1 and the key sharing system 30D-2 correspond to PSK.

Thus, in the example illustrated in FIG. 1, while the key sharing system 30A-1 exists separately from the key server 20-1, the key sharing system 30B-1, the key sharing system 30C-1, and the key sharing system 30D-1 are included in the key server 20-1. The same applies to the key sharing system 30A-2 to the key sharing system 30D-2.

Note that the key server 20-1 and the key sharing system 30A-1 are communicably connected by, for example, an in-base network or the like. Similarly, the key server 20-2 and the key sharing system 30A-2 are communicably connected by, for example, an in-base network or the like. On the other hand, the key sharing system 30B-1, the key sharing system 30C-1, and the key sharing system 30D-1 are achieved as functions provided by one or more programs installed in the key server 20-1. Similarly, the key sharing system 30B-2, the key sharing system 30C-2, and the key sharing system 30D-2 are achieved as functions provided by one or more programs installed in the key server 20-2.

Hereinafter, when the key sharing system 30A-1 to the key sharing system 30D-1 are not distinguished, they are referred to as a “key sharing system 30-1”. Similarly, when the key sharing system 30A-2 to the key sharing system 30D-2 are not distinguished, they are referred to as a “key sharing system 30-2”.

The terminal device 10-1 executes various processes using the shared key provided from the key Server 20-1. Here, the terminal device 10-1 includes an application program (hereinafter referred to as AP) 110-1. Hereinafter, the AP 110-1 is also referred to as a “master AP”.

Similarly, the terminal device 10-2 executes various processes using the shared key provided from the key server 20-2. Here, the terminal device 10-2 includes an AP 110-2. Hereinafter, the AP 110-2 is also referred to as a “slave AP”.

Hereinafter, when the terminal device 10-1 and the terminal device 10-2 are not distinguished, they are referred to as a “terminal device 10”. Similarly, when the AP 110-1 and the AP 110-2 are not distinguished, they are referred to as an “AP 110”.

The AP 110 is an application program that executes various processes using a shared key. That is, the AP 110 is an application program that functions as an SAE. Note that a detailed functional configuration example of the AP 110 will be described later.

Here, examples of various processes using the shared key include encryption/decryption of data shared between the master AP and the slave AP, random number generation using the shared key as a seed, encryption/decryption, and the like. Note that, in the following, since it is assumed that the master AP and the slave AP cannot communicate with each other, encrypted communication is not included in various processes using the shared key, but encrypted communication is not excluded, and the shared key may be used for encrypted communication between the master AP and the slave AP.

The key server 20-1 generates a shared key from one or more keys shared between the key sharing system 30-1 and the key sharing system 30-2 corresponding to one or more key sharing methods, and provides the shared key to the terminal device 10-1. Here, the key server 20-1 includes a protocol conversion unit 210-1, a key output unit 220-1 corresponding to each key sharing system 30-1, and an authentication-certification management unit 230-1. Hereinafter, the key server 20-1 is also referred to as a “master key server”. Note that, in the example illustrated in FIG. 1, the key output unit 220-1 corresponding to the key sharing system 30A-1 is a key output unit 220A-1. Similarly, the key output unit 220-1 corresponding to the key sharing system 30B-1 is the key output unit 220B-1, the key output unit 220-1 corresponding to the key sharing system 30C-1 is the key output unit 220C-1, and the key output unit 220-1 corresponding to the key sharing system 30D-1 is the key output unit 220D-1.

On the other hand, the key server 20-2 generates a shared key from one or more keys shared between the key sharing system 30-2 and the key sharing system 30-1 corresponding to one or more key sharing methods, and accumulates the shared key. Here, the key server 20-2 includes a protocol conversion unit 210-2, a key output unit 220-2 corresponding to each key sharing system 30-2, and an authentication-certification management unit 230-2. Hereinafter, the key server 20-2 is also referred to as a “slave key server”. Note that, in the example illustrated in FIG. 1, the key output unit 220-2 corresponding to the key sharing system 30A-2 is a key output unit 220A-2. Similarly, the key output unit 220-2 corresponding to the key sharing system 30B-2 is the key output unit 220B-2, the key output unit 220-2 corresponding to the key sharing system 30C-2 is the key output unit 220C-2, and the key output unit 220-2 corresponding to the key sharing system 30D-2 is the key output unit 220D-2.

Hereinafter, when the key server 20-1 and the key server 20-2 are not distinguished, they are referred to as a “key server 20”, and when the key sharing system 30-1 and the key sharing system 30-2 are not distinguished, they are referred to as a “key sharing system 30”. The others are similarly referred to as a “protocol conversion unit 210”, a “key output unit 220”, an “authentication-certification management unit 230”, and the like.

Further, when the key sharing system 30A-1 and the key sharing system 30A-2 are not distinguished, they are denoted as a “key sharing system 30A”. The others are similarly referred to as a “key sharing system 30B”, a “key sharing system 30C”, a “key sharing system 30D”, and the like.

The protocol conversion unit 210 receives (a message indicating) a key request from the AP 110, generates (derives) a shared key by using one or more keys output from one or more key output units 220 and key identification information thereof, and transmits (a message indicating) a key notification including the shared key and the shared key identification information to the AP 110. Further, when an error or the like occurs in the key sharing system 30, the protocol conversion unit 210 switches to another key sharing system 30. Note that a detailed functional configuration example of the protocol conversion unit 210 will be described later.

The key output unit 220 has a function of concealing a specific mechanism of the key sharing method executed by the key sharing system 30 corresponding to the key output unit 220, and returns a key shared by the key sharing system 30 corresponding to the key output unit 220 itself and its identification information when receiving a key request. That is, when receiving the key request from the protocol conversion unit 210, the key output unit 220 returns, to the protocol conversion unit 210, a key output including a key shared by the key sharing system 30 corresponding to the key output unit 220 and its identification information. Note that the key output unit 220 has a function of concealing a specific mechanism of the key sharing method, and thus may be referred to as, for example, a protocol driver or the like.

Thus, a specific mechanism of the key sharing method is concealed from the AP 110, and the AP 110 can obtain a shared key by simply making a key request to the protocol conversion unit 210 and by a key notification with respect to the key request.

Further, when an error or the like occurs in the key sharing system 30 corresponding to the key output unit 220, the key output unit 220 receives an error notification from the key sharing system 30 and transmits the error notification to the protocol conversion unit 210.

The authentication-certification management unit 230 manages application authentication information, server-client authentication information, and certification information. The application authentication information is information for authenticating the AP 110 in the host base, and is, for example, information (example: application ID, authentication information of AP 110) or the like indicating the AP 110 that permits the key request. The server-client authentication information is information for the key sharing system 30 in the host base to perform mutual authentication (that is, mutual authentication between KMEs) with the key sharing system 30 in the other base, and is, for example, a Server certificate and a client certificate of the key sharing system 30 in the other base permitted as a connection destination. The certification information is information for allowing the key sharing system 30 in the host base to use the key of the AP 110 in the other base, and for example, information indicating the AP 110 in the other base that can be designated as a sharing partner of the shared key by the AP 110 in the host base, and information indicating the key sharing system 30 that can be used by the AP 110 in the other base. Note that the application authentication information, the server-client authentication information, and the certification information are stored in an authentication and certification information storage area implemented by a storage device.

The application authentication information enables the protocol conversion unit 210 to reject a key request from a source other than the predetermined AP 110. Further, the key sharing system 30 can perform mutual authentication with the key sharing system 30 in the other base by the server-client authentication information, and can reject key sharing with a key sharing system other than the key sharing system 30 that has been mutually authenticated. Furthermore, according to the certification information, the key sharing system 30 can reject key sharing with a key sharing system other than the key sharing system 30 used by the predetermined AP 110 among the APs 110 in the other base, and as a result, it is possible not to authorize a key to an AP other than the predetermined AP 110.

Note that the overall configuration of the key provision system 1 illustrated in FIG. 1 is an example, and the present invention is not limited thereto. For example, in the example illustrated in FIG. 1, it is assumed that the key server 20 can use four key sharing methods, and a key sharing system 30A to a key sharing system 30D corresponding to these key sharing methods are illustrated. However, in general, the key sharing systems 30 exist in a number up to the number of key sharing methods usable by the key server 20. Specifically, for example, in a case where the key server 20 can use N key sharing methods, there are N key sharing systems 30 respectively corresponding to the N key sharing methods.

In addition, the communication network between the key servers 20 and the communication network between the key sharing systems 30 may be the same, or may be different depending on the key sharing method executed by the key sharing system 30. For example, in a case where the key sharing method executed by a certain key sharing system 30 is QKD, the communication network between the key servers 20 is the Internet or the like, and the communication network between the key sharing systems 30 is an optical communication network or the like. On the other hand, for example, when the key sharing method executed by a certain key sharing system 30 is KEM or the like, both the communication network between the key servers 20 and the communication network between the key sharing systems 30 are the Internet or the like.

### Detailed Functional Configuration Example of AP 110

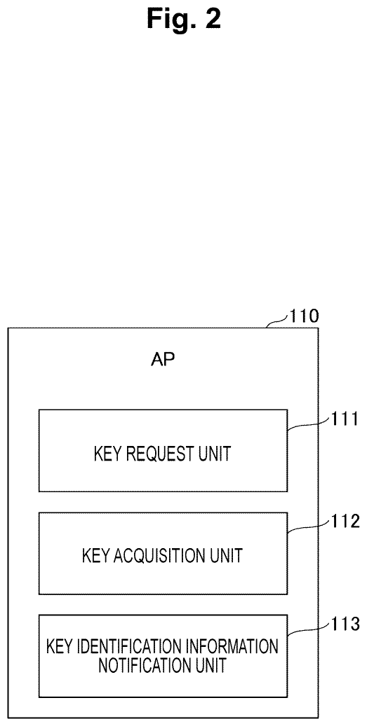

FIG. 2 illustrates a detailed functional configuration example of the AP 110 according to the embodiment. As illustrated in FIG. 2, the AP 110 according to the embodiment includes a key request unit 111, a key acquisition unit 112, and a key identification information notification unit 113.

In a case where the key request unit 111 itself is on the master side, the key request unit transmits a key request for the shared key to the protocol conversion unit 210.

When the key acquisition unit 112 itself is on the master side, the key acquisition unit acquires the shared key and the shared key identification information included in the key notification received from the protocol conversion unit 210. On the other hand, in a case where the key acquisition unit 112 itself is on the slave side, when receiving a shared key identification information notification including the shared key identification information from the protocol conversion unit 210, the key acquisition unit transmits a key acquisition request including the shared key identification information to the protocol conversion unit 210.

In a case where the key identification information notification unit 113 itself is on the master side, when acquiring the shared key and the shared key identification information, the key identification information notification unit transmits a shared key identification information notification including the shared key identification information to the protocol conversion unit 210.

### Detailed Functional Configuration Example of Protocol Conversion Unit 210

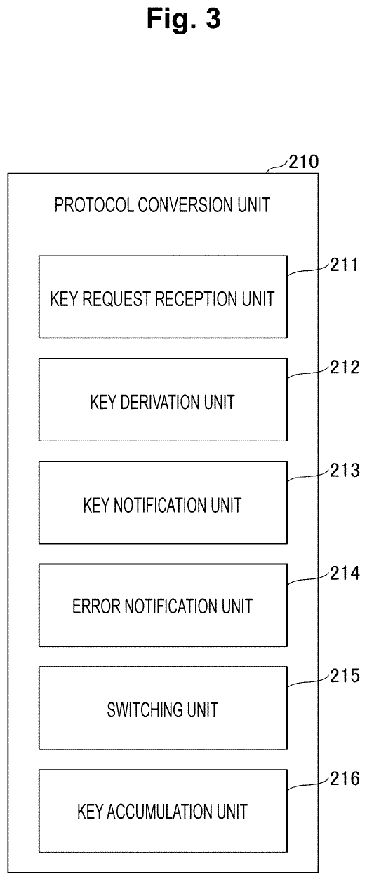

FIG. 3 illustrates a detailed functional configuration example of the protocol conversion unit 210 according to the embodiment. As illustrated in FIG. 3, the protocol conversion unit 210 according to the embodiment includes a key request reception unit 211, a key derivation unit 212, a key notification unit 213, an error notification unit 214, a switching unit 215, and a key accumulation unit 216.

The key request reception unit 211 receives a key request from the AP 110 and authenticates the AP 110 with reference to the application authentication information. Further, the key request reception unit 211 transmits the key request to the key output unit 220 corresponding to (the key sharing system 30 of) each of one or more key sharing methods currently used.

Further, the key request reception unit 211 receives the switching notification from the switching unit 215, and switches the key sharing method to be switched among the currently used key sharing methods to the key sharing method of the switching destination on the basis of the information included in the switching notification. Further, the key request reception unit 211 transmits the switching notification to the other key server 20.

The key derivation unit 212 receives the key output from each of the one or more key output units 220, and derives the shared key and the shared key identification information from the key, the key identification information, and the like included in each of the one or more key outputs. In addition, the key derivation unit 212 transmits a key output including the shared key and the shared key identification information to the key notification unit 213.

The key notification unit 213 receives the key output from the key derivation unit 212, extracts the shared key and the shared key identification information included in the key output, and then transmits a key notification including the shared key and the shared key identification information to the AP 110 or the key accumulation unit 216. Further, when receiving the shared key identification information notification from the master AP, the key notification unit 213 transmits the shared key identification information notification to the protocol conversion unit 210-2 of the key server 20-2 corresponding to the slave AP. Furthermore, when receiving the shared key identification information notification from the protocol conversion unit 210-1 of the key server 20-1 corresponding to the master AP, the key notification unit 213 transmits the shared key identification information notification to the slave AP.

The error notification unit 214 receives an error notification from the key output unit 220 and transmits the error notification to the switching unit 215.

The switching unit 215 receives the error notification from the key output unit 220, determines a key sharing method of a switching destination of the key sharing method to be switched, and then transmits, to the key request reception unit 211, a switching notification including information indicating the key sharing method to be switched and the key sharing method of the switching destination.

When a key sharing method capable of accumulating keys is being used, the key accumulation unit 216 accumulates a key generated by the key sharing method and key identification information thereof in a key storage area implemented by a storage device. Note that the key accumulated in the key storage area may be referred to as an accumulated key.

In addition, the shared key and the shared key identification information derived by the key accumulation unit 216 and the key derivation unit 212 are accumulated in a shared key storage area implemented by the storage device.

### Key Sharing Processing

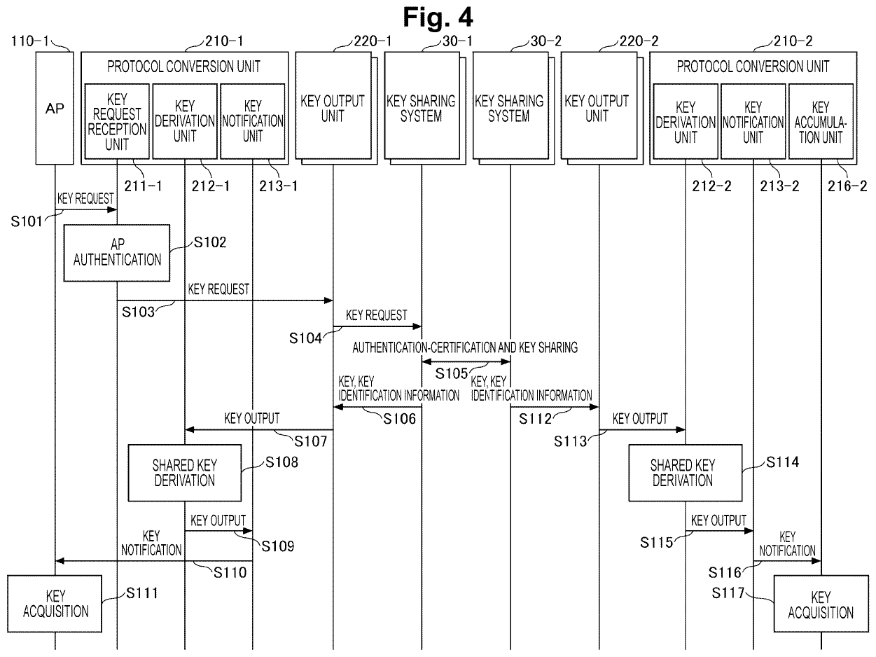

Key sharing processing for generating a shared key used by the AP 110-1 and the AP 110-2 will be described below with reference to FIG. 4. Note that the AP 110-1 is the master side, and the AP 110-2 is the slave side.

First, a key request unit 111-1 of the AP 110-1 transmits a key request to the protocol conversion unit 120-1 (step S101).

Upon receiving the key request, a key request reception unit 211-1 of the protocol conversion unit 210-1 authenticates the AP 110-1 that is the transmission source of the key request with reference to the application authentication information (step S102). For example, the key request reception unit 211-1 determines that the authentication succeeds when the application ID (alternatively, the authentication information) of the AP 110-1 that is the transmission source of the key request is included in the application authentication information, and determines that the authentication fails otherwise. When the authentication of the AP 110-1 is successful, the processing of step S103 is executed, and when the authentication is unsuccessful, the processing of step S103 and subsequent steps is not executed. In the following description, it is assumed that the authentication of the AP 110-1 is successful.

The key request reception unit 211-1 of the protocol conversion unit 210-1 transmits the key request to one or more key output units 220 corresponding to one or more key sharing methods set as the currently used key sharing method (step S103). For example, in a case where three key sharing methods “QKD”, “KEM-A”, and “KEM-B” are set as the key sharing methods currently used, the key request reception unit 211-1 transmits the key request to the key output unit 220A-1 corresponding to the key sharing system 30A-1 that performs key sharing by QKD, the key output unit 220B-1 corresponding to the key sharing system 30B-1 that performs key sharing by KEM-A, and the key output unit 220C-1 corresponding to the key sharing system 30C-1 that performs key sharing by KEM-B.

Upon receiving the key request from the key request reception unit 211-1, each key output unit 220-1 transmits the key request to the key sharing system 30-1 corresponding thereto (step S104). For example, when the key output unit 220A-1 receives the key request, the key output unit 220A-1 transmits the key request to the key sharing system 30A-1. Similarly, for example, when the key output unit 220B-1 receives the key request, the key output unit 220B-1 transmits the key request to the key sharing system 30B-1. Similarly, for example, when the key output unit 220C-1 receives the key request, the key output unit 220C-1 transmits the key request to the key sharing system 30C-1.

When receiving the key request from the key output unit 220-1 corresponding to the key sharing system 30-1, the key sharing system 30-1 performs authentication-certification with the key sharing system 30-2 corresponding to the same key sharing method as the key sharing system 30-1, and shares a key by the key sharing method (step S105). At this time, the key sharing system 30-1 and the key sharing system 30-2 perform mutual authentication using the server certificate and the client certificate included in the server-client authentication information. Further, the key sharing system 30-1 refers to the certification information and determines whether or not to give, to the AP 110-2, authorization regarding use of a key shared with the key sharing system 30-2. For example, in a case where the information indicating the key sharing system 30-2 is included in the certification information as information indicating the key sharing system 30 that can be used by the AP 110-2 that can be designated as the sharing partner of the shared key by the AP 110-1 that is the transmission source of the key request, the key sharing system 30-1 determines to authorize the use of the key to the AP 110-2, and determines not to authorize the use of the key otherwise. Note that, although only the certification information is referred to when the key sharing system 30-1 determines whether or not to authorize the use of the key, the application authentication information may be referred to in addition to the certification information in order to authenticate the AP 110-1 that is the transmission source of the key request again.

Here, when key sharing is performed between the key sharing system 30-1 and the key sharing system 30-2 in step S105 described above, key distribution and key generation are performed in addition to the mutual authentication-certification described above in the case of QKD and KEM. On the other hand, in the case of PSK, key distribution and key generation are not performed, and only the above mutual authentication-certification is performed.

Note that, in step S105 described above, the server certificate and the client certificate are used as mutual authentication between the key sharing systems 30, but this is merely an example, and the present invention is not limited thereto. Any authentication method can be used for mutual authentication between the key sharing systems 30 in step S105 described above.

The key sharing system 30-1 transmits, to the key output unit 220-1 corresponding to the key sharing system 30-1, the key shared with the key sharing system 30-2 corresponding to the same key sharing method as that of the key sharing system 30-1 in step S105 described above and its key identification information (step S106). Here, the key identification information is information for identifying a key shared with the key sharing system 30-2, and is, for example, session information such as a key ID (alternatively, in the case of QKD not using REST, it may be a session ID) in the case of QKD and a session ID or the like in the case of KEM. In the case of PSK, some information or the like depending on the protocol used for communication with a communication partner is used, but since a session is identified by these pieces of information in general, these pieces of information are also referred to as session information below.

Upon receiving the key and the key identification information from the key sharing system 30-1 corresponding to the key output unit 220-1, the key output unit transmits a key output including the key and the key identification information to the protocol conversion unit 210-1 (step S107).

Upon receiving the key output from the key output unit 220-1, a key derivation unit 212-1 of the protocol conversion unit 210-1 derives the shared key and the shared key identification information from the key, the key identification information, and the like included in the key output (step S108). For example, the key derivation unit 212-1 derives a shared key SK by SK=KDF (secretKey, label, context, key length). In addition, for example, the key derivation unit 212-1 derives, as shared key identification information SK_ID, information obtained by concatenating (for example, concatenating bit strings indicating the key identification information) the key identification information (that is, pieces of the key identification information of keys of one or more key sharing methods set as the currently used key sharing method) included in the above-described key outputs. However, the shared key identification information may be, for example, a hash value of information obtained by concatenating the key identification information included in each of the above key outputs.

Here, the KDF is a predetermined key derivation function. “secretKey” is information obtained by concatenating keys of one or more key sharing methods set as the key sharing method currently used. “label” is information obtained by concatenating labels (for example, a character string indicating the name of the key sharing method or the like) representing one or more key sharing methods set as the key sharing method currently used. “context” is information (alternatively, for example, in a case where the input length of the KDF is limited, the hash value may be used) obtained by concatenating key identification information of keys of one or more key sharing methods set as the key sharing method currently used. “key length” is a predetermined key length. However, the key identification information of keys of one or more key sharing methods used for the context is generated so as to be unique every time the key is generated in each key sharing method. If this cannot be ensured, a different value is shared every time when key sharing is performed between the base 1 and the base 2, and information indicating the value is used for the context. Thus, it is possible to ensure that the key derived by the key derivation unit 212 is different for each key sharing request.

### Specific Example 1

It is assumed that three key sharing methods “QKD”, “KEM-A”, and “KEM-B” are set as the key sharing method currently used. Further, the key of QKD is “sk”, its key identification information is “skID”, the key of KEM-A is “SK1”, its key identification information is “S11”, the key of KEM-B is “SK2”, and its key identification information is “S12”. Further, the QKD label is “QKD”, the KEM-A label is “KEM-A”, and the KEM-B label is “KEM-B”.

At this time, secretKey=sk||SK1||SK2, context=skID ||S11||S12, and label=QKD ||KEM-A||KEM-B. Here, is information concatenation (for example, concatenation of bit strings indicating the information).

Therefore, SK=KDF (sk||SK1||SK2, QKD||KEM-A||KEM-B, skID||S11||S12, key length). Further, SK_ID=skID||S11||S12.

### Specific Example 2

It is assumed that three key sharing methods “PSK”, “KEM-A”, and “KEM-B” are set as the key sharing method currently used. Further, the key of PSK is “psk”, its key identification information is “pskSession”, the key of KEM-A is “SK1”, its key identification information is “S11”, the key of KEM-B is “SK2”, and its key identification information is “S12”. Further, the PSK label is “PSK”, the KEM-A label is “KEM-A”, and the KEM-B label is “KEM-B”.

At this time, secretKey=psk||SK1||SK2, context=pskSession ||S11||S12, label=PSK ||KEM-A||KEM-B.

Therefore, SK=KDF (psk||SK1||SK2, pskSession ||KEM-A||KEM-B, pskSession ||S11||S12, key length). Further, SK_ID=pskSession ||S11||S12.

Note that, although QKD is included in the label in the above-described Specific Example 1 and PSK is included in the label in the above-described Specific Example 2, the label may be included only in a case where a plurality of key sharing methods of the same type is used among the key sharing methods currently used. For example, in the first specific example, label=KEM-A||KEM-B may be set.

Similarly, for example, label=KEM-A||KEM-B may also be set in Specific Example 2 described above.

The key derivation unit 212-1 of the protocol conversion unit 210-1 transmits a key output including the shared key SK and the shared key identification information SK_ID derived in step S108 described above to a key notification unit 213-1 (step S109).

Upon receiving the key output from the key derivation unit 212-1, the key notification unit 213-1 of the protocol conversion unit 210-1 extracts the shared key SK and the shared key identification information SK_ID included in the key output, and then transmits a key notification including the shared key SK and the shared key identification information SK_ID to the AP 110-1 (step S110).

Upon receiving the key notification from the protocol conversion unit 210-1, a key acquisition unit 112-1 of the AP 110-1 acquires the shared key SK and the shared key identification information SK_ID included in the key notification (step S111). Thus, the master AP can obtain the shared key SK and the shared key identification information SK_ID.

On the other hand, each of the key sharing systems 30-2 transmits, to the key output unit 220-2 corresponding to the key sharing system 30-2, the key shared with the key sharing system 30-1 corresponding to the same key sharing method as that of the key sharing system 30-2 in step S105 described above and its key identification information (step S112).

Upon receiving the key and the key identification information from the key sharing system 30-2 corresponding to each key output unit 220-2, each key output unit transmits a key output including the key and the key identification information to the protocol conversion unit 210-2 (step S113).

Upon receiving the key output from each key output unit 220-2, a key derivation unit 212-2 of the protocol conversion unit 210-2 derives the shared key and the shared key identification information from the key, the key identification information, and the like included in each of the key outputs (step S114). Note that the key derivation unit 212-2 derives the shared key SK and the shared key identification information SK_ID by a method similar to that in step S108 described above.

The key derivation unit 212-2 of the protocol conversion unit 210-2 transmits a key output including the shared key SK and the shared key identification information SK_ID derived in step S114 described above to a key notification unit 213-2 (step S115).

Upon receiving the key output from the key derivation unit 212-2, the key notification unit 213-2 of the protocol conversion unit 210-2 extracts the shared key SK and the shared key identification information SK_ID included in the key output, and then transmits a key notification including the shared key SK and the shared key identification information SK_ID to a key accumulation unit 216-2 (step S116).

Upon receiving the key notification from the key notification unit 213-2, the key accumulation unit 216-2 of the protocol conversion unit 210-2 acquires the shared key SK and the shared key identification information SK_ID included in the key notification and accumulates them in the shared key storage area (step S117).

Note that when the key is shared in step S105 described above, it is not limited to a case where a new key is generated between the key sharing systems 30, and for example, in a case where the key accumulation unit 216 accumulates a key (accumulated key), the accumulated key may be shared. In particular, for example, the accumulated key may be shared in a case where a new key cannot be generated for some reason such as occurrence of an error. In this case, for example, the key output unit 220 only needs to transmit an acquisition request for an accumulated key to the key accumulation unit 216 in response to a request from the key sharing system 30. Thus, since the accumulated key is returned from the key accumulation unit 216 to the key output unit 220, the key output unit 220 only needs to transmit the key output including the accumulated key to the key derivation unit 212.

Furthermore, in the key sharing processing described above, the shared key SK used by the slave AP is accumulated in step S117 described above, but the present invention is not limited thereto, and for example, the key notification unit 213-2 may transmit a key notification to the slave AP (AP 110-2) in step S116 described above.

### Shared Key Use Start Processing

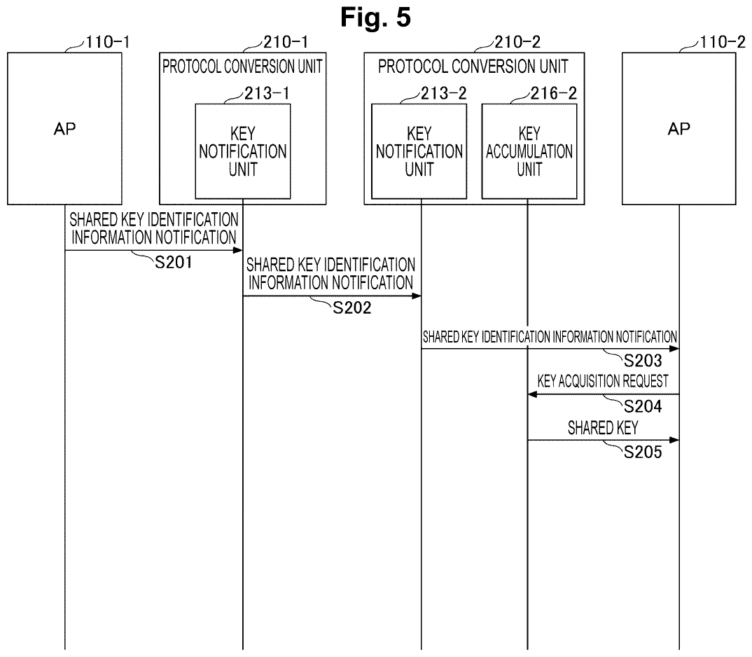

Hereinafter, shared key use start processing for the AP 110-1 to start using the shared key with the AP 110-2 will be described with reference to FIG. 5. Note that the AP 110-1 is the master side, and the AP 110-2 is the slave side.

The key identification information notification unit 113 of the AP 110-1 transmits the shared key identification information notification including the shared key identification information SK_ID to the protocol conversion unit 210-1 (step S201).

Upon receiving the shared key identification information notification from the AP 110-1, the key notification unit 213-1 of the protocol conversion unit 210-1 transmits the shared key identification information notification to the protocol conversion unit 210-2 (step S202).

Upon receiving the shared key identification information notification from the protocol conversion unit 210-1, the key notification unit 213-2 of the protocol conversion unit 210-2 transmits the shared key identification information notification to the AP 110-2 (step S203).

Upon receiving the shared key identification information notification from the protocol conversion unit 210-2, the key acquisition unit 112 of the AP 110-2 extracts the shared key identification information SK_ID included in the shared key identification information notification, and then transmits a key acquisition request including the shared key identification information SK_ID to the protocol conversion unit 210-2 (step S204).

Upon receiving the key acquisition request from the AP 110-2, the key accumulation unit 216-2 of the protocol conversion unit 210-2 acquires the shared key SK identified by the shared key identification information SK_ID included in the key acquisition request from the shared key storage area, and then transmits the shared key SK to the AP 110-2 (step S205). Thus, the slave AP (AP 110-2) can obtain the same shared key SK as the master AP.

As described above, by notifying the protocol conversion unit 210-1 of the shared key identification information SK_ID in a callback manner from the master AP that has acquired the shared key SK and the shared key identification information SK_ID, the slave AP is notified of the shared key identification information SK_ID via the protocol conversion unit 210-1 and the protocol conversion unit 210-2. Thus, even when communication cannot be performed between the master AP and the slave AP, it is possible to notify the slave AP of the shared key identification information SK_ID from the master AP.

### Usage Example of Shared Key

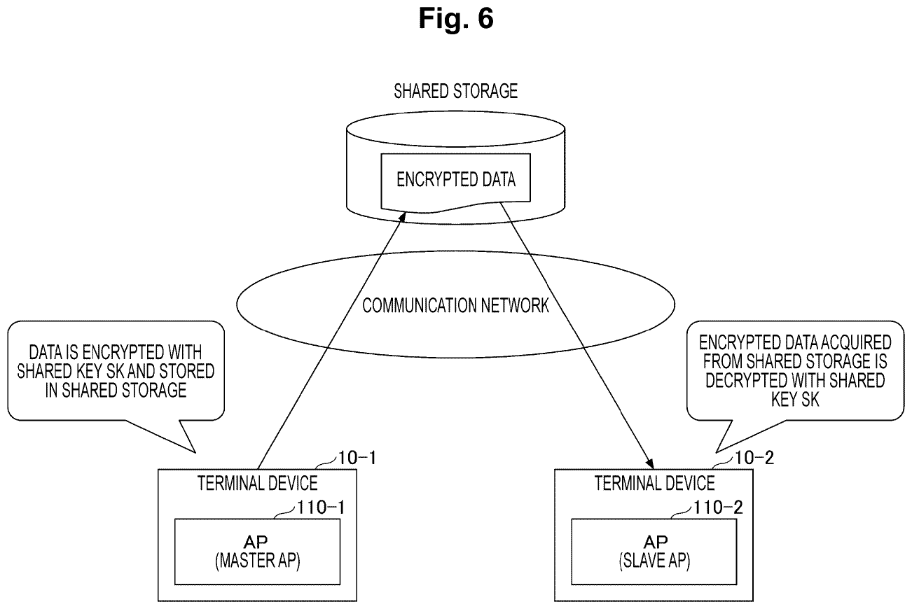

A usage example of the shared key SK shared between the master AP and the slave AP in the shared key use start processing will be described with reference to FIG. 6. FIG. 6 illustrates a usage example in a case where data is shared via a shared storage.

First, the AP 110-1 stores encrypted data obtained by encrypting data to be shared with the shared key SK in the shared storage. Next, the AP 110-2 acquires the encrypted data from the shared storage and decrypts the encrypted data with the shared key SK. Thus, data sharing can be implemented between the master AP and the slave AP.

Note that the usage example illustrated in FIG. 6 is an example, and the usage example of the shared key SK is not limited thereto. For example, it may be used for random number generation using the shared key SK as a seed, encryption, decryption, and the like, or may be used for encrypted communication (for example, asynchronous encrypted communication via a message server or the like) using the shared key SK.

### Switching Processing

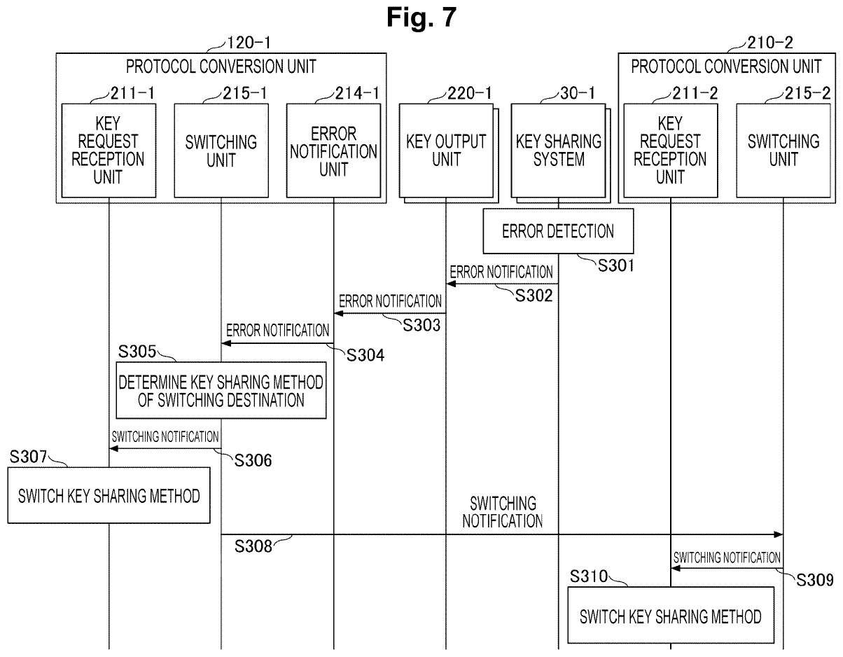

Hereinafter, as an example, switching processing in a case where some error occurs in the key sharing system 30-1 corresponding to a certain key sharing method among one or more key sharing methods set as the currently used key sharing method and the key sharing method is switched to another key sharing method will be described with reference to FIG. 7.

The key sharing system 30-1 detects the occurrence of an error (step S301). Here, various errors are conceivable as errors occurring in the key sharing system 30-1 and the present embodiment can target any error, but for example, the following errors can be targeted. Note that the error may be, for example, what is called a failure, an abnormality, or the like.
(1) Key request error (for example, a communication error when key sharing with the key sharing system 30-2 is performed, an internal error of the key sharing system 30-1 when key sharing is performed, and the like)
(2) Key exhaustion (exhaustion of keys accumulated by the key accumulation unit 216 is also included)
(3) Computing capacity exhaustion
(4) System error
(5) Tamper abnormality

Note that, for example, an event in which key sharing becomes impossible due to tapping on an optical fiber cable used by the key sharing system 30-1 corresponding to QKD may occur, and such an event may be detected as tamper abnormality.

The key sharing system 30-1 transmits an error notification related to the error detected in step S301 described above to the key output unit 220-1 corresponding thereto (step S302). Note that the error notification includes, for example, information indicating the key sharing system 30 in which the error has been detected, the content of the error, the cause of the error, and the like.

Upon receiving the error notification from the key sharing system 30-1, the key output unit 220-1 transmits the error notification to the protocol conversion unit 210-1 (step S303).

Upon receiving the error notification from the key output unit 220-1, an error notification unit 214-1 of the protocol conversion unit 210-1 transmits the error notification to a switching unit 215-1 (step S304).

Upon receiving the error notification from the error notification unit 214-1, the switching unit 215-1 of the protocol conversion unit 210-1 determines a key sharing method to be a switching destination of the key sharing method corresponding to the key sharing system 30-1 in which the error has been detected (step S305). Here, the switching unit 215 can determine the key sharing method to be the switching destination by various methods, and for example, it is conceivable to determine the key sharing method to be the switching destination by the following method.
(a) The key sharing method to be the switching destination is determined according to the error content or the error cause included in the error notification. This is, for example, a method in which an error content or an error cause is associated with a key sharing method to be a switching destination in advance for each key sharing method, and the key sharing method to be the switching destination is determined based on the correspondence.
(b) One key sharing method is determined as a switching destination randomly or in a predetermined order (predetermined priority order) from among key sharing methods other than the key sharing method to be switched.
(c) An error content or an error cause included in the error notification is notified to the AP 110 or the user, and a key sharing method to be a switching destination is determined according to an instruction from the AP 110 or an instruction from the user. In this case, since the AP 110 or the user can confirm the error content or the error cause, an appropriate key sharing method can be determined as the switching destination according to the error content or the error cause.

Note that any of the above determination methods is an example, and the key sharing method to be the switching destination may be determined by other various methods. In addition, for example, in a case where the key accumulation unit 216 accumulates a key in the key storage area, it may be determined to switch the acquisition destination of the key of the key sharing method corresponding to the key sharing system 30 in which the error is detected to the accumulated key of the key storage area. Thus, the accumulated key is used until the accumulated key is exhausted, and the key sharing method can be switched after the accumulated key is exhausted. In the following description, it is assumed that a key sharing method to be a switching destination is determined.

The switching unit 215-1 of the protocol conversion unit 210-1 sets the key sharing method corresponding to the key sharing system 30-1 in which the error is detected as the key sharing method to be switched, and sets the key sharing method determined in step S305 described above as the key sharing method of a switching destination, and transmits, to the key request reception unit 211-1, a switching notification including information indicating the key sharing method to be switched and information indicating the key sharing method of the switching destination (step S306).

Upon receiving the switching notification from the switching unit 215-1, the key request reception unit 211-1 of the protocol conversion unit 210-1 switches the key sharing method to be switched among the one or more key sharing methods set as the key sharing method currently used to the key sharing method of the switching destination on the basis of the information indicating the key sharing method to be switched and the information indicating the key sharing method of the switching destination included in the switching notification (step S307).

Further, the switching unit 215-1 of the protocol conversion unit 210-1 transmits the switching notification to the protocol conversion unit 210-2 (step S308).

Upon receiving the switching notification from the protocol conversion unit 210-2, a switching unit 215-2 of the protocol conversion unit 210-2 transmits the switching notification to a key request reception unit 211-2 (step S309).

Upon receiving the switching notification from the switching unit 215-2, the key request reception unit 211-2 of the protocol conversion unit 210-2 switches the key sharing method to be switched among the one or more key sharing methods set as the key sharing method currently used to the key sharing method of the switching destination on the basis of the information indicating the key sharing method to be switched and the information indicating the key sharing method of the switching destination included in the switching notification (step S310).

As described above, when an error or the like occurs in a certain key sharing system 30 and the key sharing system 30 becomes unable to share the key, it is possible to switch to generate the key in another key sharing system 30. In addition, in a case where the accumulated key exists, it is also possible to switch to use the accumulated key. Therefore, even in a case where the key sharing system 30 cannot be used, the shared key can be continuously derived, and the AP 110 can continue to use the shared key.

### Hardware Configuration Example

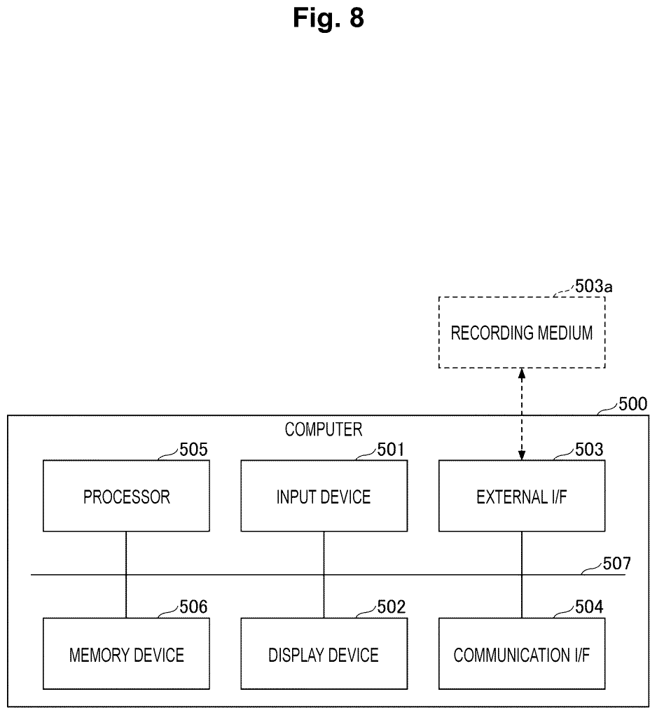

The terminal device 10, the key server 20, and the key sharing system 30 corresponding to QKD included in the key provision system 1 according to the above-described embodiment can be implemented by, for example, a hardware configuration of a computer 500 illustrated in FIG. 8. The computer 500 illustrated in FIG. 8 includes an input device 501, a display device 502, an external I/F 503, a communication I/F 504, a processor 505, and a memory device 506. Each of these pieces of hardware is communicably connected via a bus 507.

The input device 501 is, for example, a keyboard, a mouse, a touch panel, a physical button of various types, or the like. The display device 502 is, for example, a display, a display panel, or the like. Note that the computer 500 is not required to include at least one of the input device 501 or the display device 502, for example.

The external I/F 503 is an interface with an external device such as a recording medium 503a. Examples of the recording medium 503a include a CD-ROM, a DVD-ROM, an SD memory card, a USB memory card, and the like.

The communication I/F 504 is an interface for connecting the computer 500 to a communication network. The processor 505 is, for example, any of various arithmetic devices such as a central processing unit (CPU). The memory device 506 is, for example, any of various storage devices such as a hard disk drive (HDD), a solid state drive (SSD), a random access memory (RAM), a read only memory (ROM), or a flash memory.

However, the hardware configuration of the computer 500 illustrated in FIG. 8 is an example, and the hardware configuration is not limited thereto. For example, the computer 500 may include a plurality of processors 505 and a plurality of memory devices 506, is not required to include a part of the illustrated hardware, or may include various hardware other than the illustrated hardware.

Note that one or more programs for implementing the AP 110 illustrated in FIG. 1 are stored in the memory device 506 included in the terminal device 10, and the processor 505 included in the terminal device 10 executes various processes by the one or more programs to implement various functions. Similarly, one or more programs for implementing the key sharing system 30 corresponding to the key sharing method (for example, PSK, KEM, or the like) in which the SAE and the KME exist on the same device when modeling similar to the protocol conversion unit 210, the key output unit 220, and QKD illustrated in FIG. 1 are stored in the memory device 506 included in the key server 20, and various functions are implemented by the processor 505 included in the key server 20 executing various processes according to the one or more programs.

### Conclusion

As Described Above, in the Key Provision system 1 according to the above-described embodiment, it is possible to provide the AP 110 (application program) with a shared key obtained by combining keys of one or more key sharing methods. Moreover, even in a case where the authentication-certification method and the key identification method are different depending on each key sharing method, it is possible to perform unified authentication-certification and key identification, and it is possible to generate a shared key combining keys of a plurality of key sharing methods without deteriorating security.

In addition, even in a case where communication cannot be performed between the master AP and the slave AP, by notifying the key server 20 of the shared key identification information in a callback manner from the master AP that has acquired the shared key, it is possible to notify the slave AP of the shared key identification information via the key server 20. Therefore, even when communication cannot be performed between the master AP and the slave AP, the shared key can be shared between these APs.

In addition to the above, in the key provision system 1 according to the above-described embodiment, when a certain key sharing method cannot be used for some reason, it is possible to switch to another key sharing method. Therefore, the availability of the service implemented by the application program using the shared key can be increased, and the service quality can be improved.

The present invention is not limited to the above embodiment specifically disclosed, and various modifications and changes, combinations with known techniques, and the like can be made without departing from the scope of the claims.

### REFERENCE SIGNS LIST

1 Key provision system
10 Terminal device
20 Key server
30 Key sharing system
110 AP
111 Key request unit
112 Key acquisition unit
113 Key identification information notification unit
210 Protocol conversion unit
211 Key request reception unit
212 Key derivation unit
213 Key notification unit
214 Error notification unit
215 Switching unit
216 Key accumulation unit
220 Key output unit
230 Authentication-certification management unit
500 Computer
501 Input device
502 Display device
503 External I/F
503a Recording medium
504 Communication I/F
505 Processor
506 Memory device
507 Bus

1. A key providing system comprising a first terminal on a master side of key sharing, a first key server capable of providing a shared key to the first terminal, a second terminal on a slave side of the key sharing, and a second key server capable of providing a shared key to the second terminal, wherein
the first key server is configured to:
generate, when receiving a key request from the first terminal, by using one or more keys shared with the second key server by one or more key sharing methods and first identification information for identifying each of the one or more keys, the shared key and second identification information for identifying the shared key;
transmit a key notification including the shared key and the second identification information to the first terminal; and
transmit, when receiving the second identification information from the first terminal, the second identification information to the second key server, and
the second key server is configured to:
generate, by using the one or more keys shared with the first key server by the one or more key sharing methods and first identification information for identifying each of the one or more keys, the shared key and the second identification information;
transmit, when receiving the second identification information from the first key server, the second identification information to the second terminal; and
transmit, when receiving a key acquisition request including the second identification information from the second terminal, the shared key identified by the second identification information to the second terminal.

2. The key providing system according to claim 1, wherein
the first terminal is configured to, when receiving the key notification from the first key server, transmit the second identification information included in the key notification to the first key server, and
the second terminal is configured to, when receiving the second identification information from the second key server, transmit the key acquisition request including the second identification information to the second key server.

3. The key providing system according to claim 1, wherein the shared key is information used for predetermined processing in the first terminal and the second terminal that cannot communicate with each other.

4. A method used in a key providing system including a first terminal on a master side of key sharing, a first key server capable of providing a shared key to the first terminal, a second terminal on a slave side of the key sharing, and a second key server capable of providing a shared key to the second terminal, the method comprising:
generating, by the first key server, when receiving a key request from the first terminal, by using one or more keys shared with the second key server by one or more key sharing methods and first identification information for identifying each of the one or more keys, the shared key and second identification information for identifying the shared key,
transmitting, by the first key server, a key notification including the shared key and the second identification information to the first terminal, and
transmitting, by the first key server, when receiving the second identification information from the first terminal, the second identification information to the second key server; and
generating, by the second key server, by using the one or more keys shared with the first key server by the one or more key sharing methods and first identification information for identifying each of the one or more keys, the shared key and the second identification information,
transmitting, by the second key server, when receiving the second identification information from the first key server, the second identification information to the second terminal, and
transmitting, by the second key server, when receiving a key acquisition request including the second identification information from the second terminal, the shared key identified by the second identification information to the second terminal.

5. A non-transitory computer-readable recording medium having stored therein a program for causing a computer to perform the method according to claim 4.
